(19) United States
(12) Patent Application Publication
(10) Pub. No.: US 2005/0018009 A1
(43) Pub. Date: Jan. 27, 2005

(54) Waste ink tank and ink jet printer apparatus using the same

(75) Inventor: Kensei Otsubo, Fukuoka (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 10/892,162

(22) Filed: Jul. 16, 2004

(30) Foreign Application Priority Data
Jul. 17, 2003 (JP) P. 2003-198319
Oct. 29, 2003 (JP) P. 2003-368665

(51) Int. Cl. B41J 2/165

(52) U.S. Cl. 347/36

(57) ABSTRACT

In a waste ink tank provided with a storing part in which waste ink ejected from an ink nozzle is stored, there are provided a waste ink inlet which catches the waste ink ejected from the ink nozzle and leads it to the storing part, and a sweeping mechanism for sweeping the waste ink that stays downward of the waste ink inlet. The sweeping mechanism comprises a scraper that slides, and a slant surface located downward of the waste ink inlet, on which the scraper slides, and an ink absorber for absorbing the waste ink ejected from the ink nozzle is provided on one side of the slide surface.

### BACKGROUND OF THE INVENTION

The present invention relates to a waste ink tank used in ejection in order to prevent clogging of a head of an ink jet printer, and an ink jet printer apparatus using this tank.

An ink jet printer apparatus has such structure that ink is ejected from a point of an ink nozzle thereby to perform printing on a printing medium such as paper. Therefore, in case that the ink jet printer apparatus is not used for a while, the ink hardens and clogs in an ejection port of the ink nozzle, or foreign matter and air bubbles clog in the ejection port, so that bad printing is produced.

Therefore, in the ink jet printer apparatus, in case that an interval of printing becomes long, or in case that the foreign matter or air bubbles clog, the ink is wastefully ejected from the ink nozzle, and the hardening ink, the foreign matter, and the air bubbles are forcedly exhausted to the outside of the ejection port together with the ink, thereby to clean the ink nozzle.

The ink jet printer apparatus having such the mechanism is provided with a waste ink tank having an ink absorber such as a sponge or a felt in order to store the ink ejected wastefully. However, in case of ink using a pigment, since it hardens as time elapses, in case that the waste ink does not diffuse in the whole of the ink absorber, the ink is absorbed in only a part to which the ink is ejected wastefully, so that deterioration of absorption power of the ink absorber is caused.

Therefore, a related art has been disclosed, in which an ink absorber is attached into a waste ink tank, and a waste ink discharge tube having many openings in the longitudinal direction of the inside of the ink absorber is uniformly provided round in the waste ink absorber. Hereby, since the waste ink is absorbed into the ink absorber from the plural openings, the waste ink is effectively absorbed into the ink absorber (for example, JP-A-6-340092).

Further, a waste ink tank has been disclosed, in which a slit of a recess part is provided for an ink absorber housed in the waste ink tank, whereby the waste ink, even if hardens, is absorbed along the slit into the ink absorber, so that the waste ink can be absorbed into the whole of the waste ink absorber without increasing the number of parts (for example, refer to JP-A-2000-127439).

In the ink jet printer apparatus using such the waste ink tank, in case that the waste ink absorber in the waste ink tank is full of the absorbed waste ink, it is necessary to give a warning before the waste ink leaks from the waste ink tank.

Further, a related art has been disclosed, in which under the constitution in which waste ink used for head cleaning is exhausted to a waste ink tank through a tube or a sponge-like ink absorbing material, the number of head cleaning is counted thereby to calculate the amount of the exhausted waste ink, and compared with the waste ink tank capacity, a warning is given (for example, refer to JP-A-6-210875 or JP-A-2000-141704).

In the waste ink tank according to JP-A-6-340092, since the waste ink is exhausted into the waste ink absorber through the small openings of the waste ink discharge tube that is a slender tube, in case that the waste ink remaining into the waste ink discharge tube hardens, it is supposed that clogging is produced and the waste ink can not be exhausted into the waste ink tank.

Further, in the waste ink tank according to JP-A-2000-127439 the Patent Reference 2, it is thought: as the waste ink is hardening, the waste ink is piled up like a mountain rather than flows along the slit because viscosity of the waste ink is high. Therefore, the waste ink is piled up higher than the height of the ink absorber and leaks from the waste ink tank.

As described above, in case that the waste ink hardens, it is piled up in the waste ink tank, or clogging is caused in the tube through which the waste ink is exhausted to the waste ink tank. Therefore, only the quantity of the waste ink that is much smaller than the quantity of waste ink that can be stored into the waste ink tank can be stored.

Also in the ink jet printer apparatuses according to JP-A-6-210875 and JP-A-141704, since the waste ink reaches the waste ink tank through the tube or the sponge-like ink absorbing material, when the waste ink hardens, it does not flow on the part where it hardens and later.

### SUMMARY OF THE INVENTION

It is an object of the invention to provide a waste ink tank which can readily remove waste ink that is ejected from an ink nozzle and hardens with passage of time, and an ink jet printer apparatus using this ink tank.

In order to achieve this object, the waste ink tank of the invention includes a waste ink inlet which catches the waste ink ejected from the ink nozzle and leads it to a storing part, and a sweeping mechanism for sweeping the waste ink that stays on the downside of the waste ink inlet.

Hereby, even in case that the waste ink ejected from the ink nozzle hardens with passage of time, the piled waste ink can be swept and moved by the sweeping mechanism provided for the waste ink tank, so that the ink amount that the waste ink tank can store can be effectively utilized.

### BRIEF DESCRIPTION OF THE DRAWINGS

FIG. 1 is a perspective view that explains a first constitution of a waste ink tank according to a first embodiment of the invention;

FIG. 2 is a perspective view that explains the first constitution of the waste ink tank according to the first embodiment of the invention, in which a cover is opened;

FIG. 3 is a plan view that explains the first constitution of the waste ink tank according to the first embodiment of the invention, in which the cover is opened;

FIG. 4 is a perspective view that explains a second constitution of the waste ink tank according to the first embodiment of the invention, in which the cover is opened;

FIG. 5 is a plan view that explains the second constitution of the waste ink tank according to the first embodiment of the invention, in which the cover is opened;

FIG. 6 is a perspective view of a printer section of an ink jet printer apparatus using the waste ink tank according to the first embodiment of the invention;

FIG. 7 is a constitutional view of a control section of the ink jet printer apparatus using the waste ink tank according to the first embodiment of the invention;

FIG. 8 is a flowchart that explains an operation of the ink jet printer apparatus using the waste ink tank according to the first embodiment of the invention;

FIG. 9 is a perspective view showing an example of constitutions of a cleaning unit and a waste ink tank-cleaning unit of an ink jet printer apparatus using a waste ink tank according to a second embodiment of the invention;

FIG. 10 is a perspective view that explains a first constitution of a waste ink tank according to a first embodiment of the invention;

FIG. 11 is a perspective view showing an automatic opening and closing mechanism to open and close a shutter of a waste ink tank in association with an operation of capping unit according to third embodiment;

FIG. 12 is an enlarged view showing apart of the automatic opening and closing mechanism and waste ink tank;

FIGS. 13A and 13B are enlarged views showing a part of capping unit and an ink cartridge; and

FIGS. 14A and 14B are perspective views of a portable color facsimile as an example of the ink jet printer apparatus according to the invention.

### DETAILED DESCRIPTION OF THE PREFERRED EMBODIMENT

(Embodiment 1)

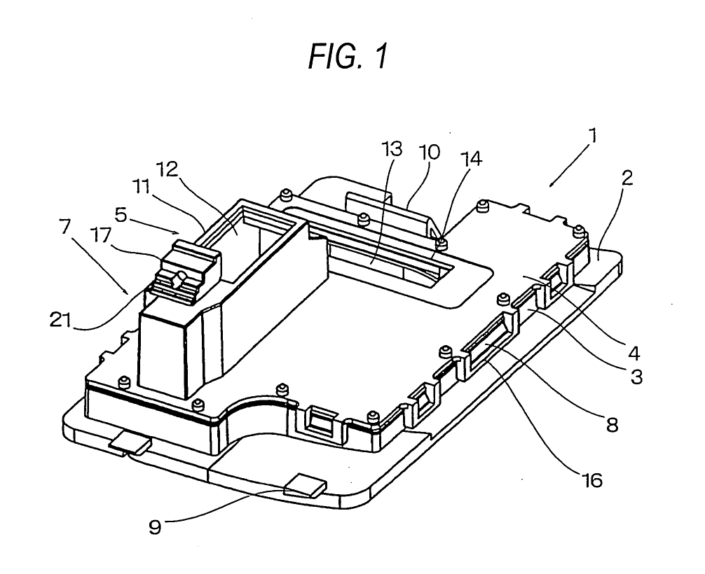

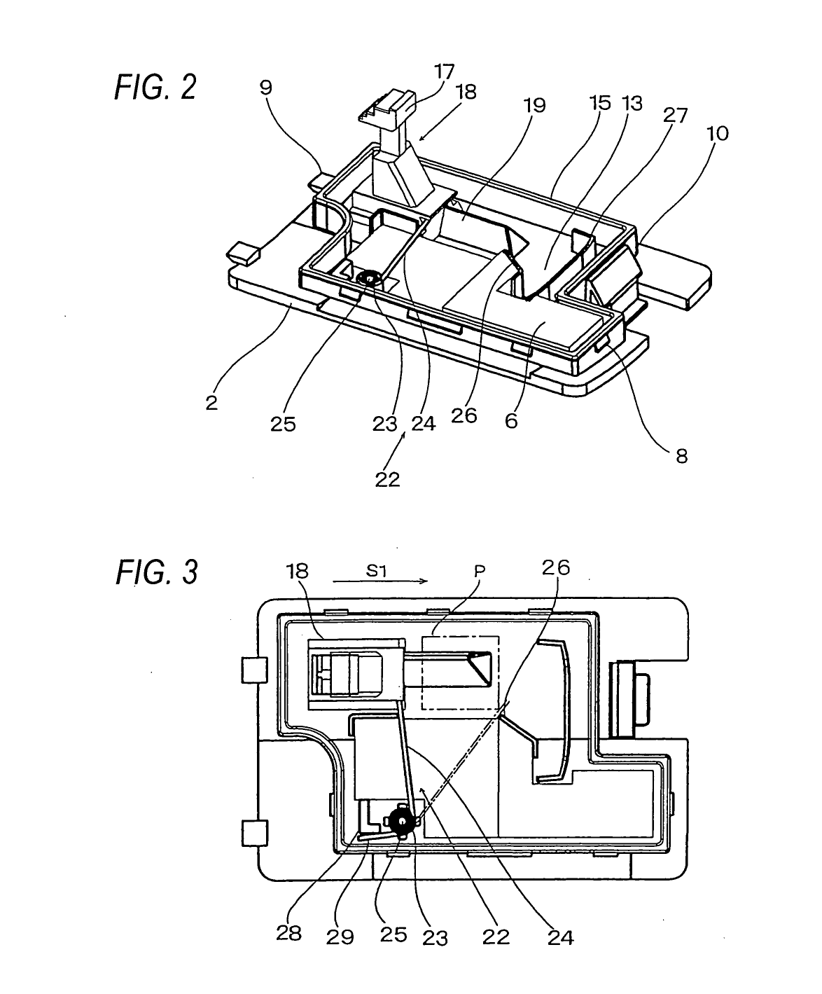

A first constitution of a waste ink tank according to a first embodiment of the invention will be described with reference to FIGS. 1 to 3. FIG. 1 a perspective view that explains the first constitution of the waste ink tank according to the first embodiment of the invention; FIG. 2 is a perspective view that explains the first constitution of the waste ink tank according to the first embodiment of the invention, in which a cover is opened; and FIG. 3 is a plan view that explains the first constitution of the waste ink tank according to the first embodiment of the invention, in which the cover is opened.

As shown in FIGS. 1 and 2, a waste ink tank 1 comprises a base plate 2, a wall part 3, a cover 4 attached onto the upside of the side part 3 by screws or tightened by fitting between a fixing claw 8 and a fixing part 16 formed nearly in the shape of C, a sweeping mechanism 5, and a waste ink absorber 6.

A storing part 7 stores the waste ink in space formed by the base plate 2, the wall part 3, and the cover 4.

The base plate 2 is formed from plastic in the nearly rectangular shape, in which the wall part 3, the fixing claw 8 formed at the side part 3 in order to fixing the cover 4, a lock claw 9 formed at one end in order to be attached to an ink jet printer apparatus (not shown), and a lock claw 10 formed at the other end are integrally formed.

In the cover 4, a waste ink introducing part 11 is formed protrusively, which catches the waste ink ejected from an ink nozzle (not shown) and leads it into the storing part 7. At the waste ink introducing part 11, an opening part is formed, which functions as a waste ink inlet 12 that is used for both of a guide when the sweeping mechanism 5 slides and an inlet of the waste ink ejected when the ink nozzle ejects ink wastefully.

Further, in the cover 4, a cleaning port 14 is formed, which is an opening part through which the waste ink swept by the sweeping mechanism 5 is taken out from the storing part 7. In case of maintenance of the waste ink tank 1, a swab or the like is inserted from the cleaning port 14 to remove the waste ink hardening in the storing part 7 so that the waste ink is twined around a tip of the swab.

The amount of the waste ink ejected wastefully from the ink nozzle in a fixed period is different in using frequency of the ink jet printer apparatus. In case that the using frequency of the ink jet printer apparatus is low, and an apparatus's life is shorter than a period when the amount of the waste ink stored in the waste ink tank 1 exceeds an allowable amount, the waste ink tank may be used up and then discarded without providing the cleaning port 14.

Regarding the wall part 3 and the cover 4, they are fixed by the fixing part 16 formed in the cover 4 nearly in the shape of C, and the fixing claw 8 formed at the wall part 3, and a gasket is put between them to fix them with screws or tighten them by claw parts between their resins, whereby close attachment is improved and leakage of ink is prevented.

The sweeping mechanism 5 includes a slant surface 19 for leading the waste ink into the ink absorber 6, and a scraper 18 which comes into contact with the slant surface 19 and slides in a nearly perpendicular direction to the slant direction of the slant surface thereby to gather the waste ink.

A lever 17 is formed stepwise and its perpendicular section is nearly triangular. The lever 17, so that it can slide by readily pushing its surface formed stepwise with a finger, is formed on the opposite side to the waste ink inlet 12 side. Further, a slide insertion part 21 that is a recess part opening in the lever 17 at a diameter of about 2 mm is formed on the surface formed stepwise. In case that the lever 17 is difficult to be slid by the operation with the finger when the waste ink tank 1 is incorporated into the ink jet printer apparatus, a matter having a sharp leading end such as a pencil or a ballpoint pen is inserted into the slide insertion part 21 to push the lever 17, whereby the scraper 18 can be readily slid.

In case that the slide insertion part 21 is formed on the waste ink inlet 12 side or on the upper surface of the lever 17, a matter having a L-shaped leading end may be inserted into the recess part to catch and slide the lever 17. In case that the lever 17 is thus slid by the pulling operation, it is desirable that the slide insertion part is formed in the shape of L or in the shape of a ring so that the slide insertion part is readily caught.

As shown in FIG. 3, after the scraper 18 has slid in a direction S1 and moved on the slant surface 19 to a position P shown by chain lines, it is energized by a spring 22 so as to return to the first position.

The spring 22 is a wire made of metal, and formed in the shape of V. At a bending part of the spring 22, a helical ring part 23 is formed. The ring part 23 is rotatably inserted to a nearly cylindrical support 25 formed integrally with the base plate 2, a turn part 24 that is an one end part of the spring 22 is detachably brought into contact with the scraper 18, and an inhibition part 29 that is the other end part of the spring 22 comes into contact with an inhibition piece 28 detachably.

When the scraper 18 is slid in the direction S1, the turn part 24 is pressed. However, since turning of the inhibition part 29 about the ring part 23 is inhibited by the inhibition piece 28, when the sliding operation of the scraper 18 is stopped, the turn part 24 returns the scraper 18 from the position P to the first position by the energizing power of the ring part 23.

Further, since the turn part 24 comes into contact with a spring stopping part 25 formed on the base plate 2 and turning of the turn part 24 is inhibited, sliding of the scraper 18 in the direction S1 from the position P is inhibited.

The slant surface 19 is formed downward of the waste ink inlet 12 of the waste ink introducing part 11 integrally with the base plate 2, receives the waste ink exhausted from the ink nozzle due to the waste ejection, and flows the waste ink to the ink absorber 6 side. Since the ink absorber 6 is arranged on only one side in a short direction of the slant surface 19, the ink absorber 6 side of the slant surface 19 is formed more widely than the opposite side thereof so that the waste ink ejected from the ink nozzle is easy to flow to the ink absorber. 6 side.

The scraper 18 slides and sweeps up the waste ink on the slant surface 19, and the swept waste ink is stored into a waste ink storing part 13 of the storing part 7 located forward in the slide direction of the scraper 18. Further, a waste ink guide 27 is formed so that the waste ink is not scattered in the storing part 7 at this time.

As described above, the scraper 18 comes into contact with the waste ink ejected on the slant surface 19 due to the waste ejection from the ink nozzle, and scrapes it while sliding, whereby it is prevented that the waste ink hardens and is piled up near the downside of the waste ink inlet 12 in each ejection, the opening part of the waste ink inlet 12 is clogged with the piled waste ink, and ink storage reaches a limit with the amount of ink that is smaller than the ink amount which the storing part 7 can store.

The ink absorber 6 absorbs the waste ink that has been ejected from the ink nozzle and has flown on the slant surface 19. As the ink absorber 6, a porous absorber such as a sponge, or a fiber absorber such as felt laminated paper can be used. However, as long as the ink absorber can absorb and hold the waste ink, any ink absorber may be used. In the ink absorber 6, a range in which the spring part 22 turns is lower in height than a range in which the spring part 21 does not turn.

Further, the ink absorber 6 is attached detachably from the storing part 7. Therefore, the cover 4 is detached, and the ink absorber 6 in which the waste ink has been absorbed can be exchanged to a new ink absorber 6 in which the waste ink has not been absorbed yet.

Since the waste ink is absorbed in the ink absorber 6 without being reused, by only exchanging the ink absorber 6, the waste ink tank 1 can be reused, and a running cost can be reduced, so that increase of industrial waste products is inhibited.

Further, since the waste ink is not reused, the waste ink tank does not require a waste ink taking-out mechanism, and the ink jet printer apparatus does not require a mechanism of returning the waste ink taken out from the waste ink tank to the ink cartridge, so that the structures of the waste ink tank and the ink jet printer apparatus can be made simple. Therefore, their sizes can be reduced readily, and a cost of the ink jet printer apparatus can be reduced.

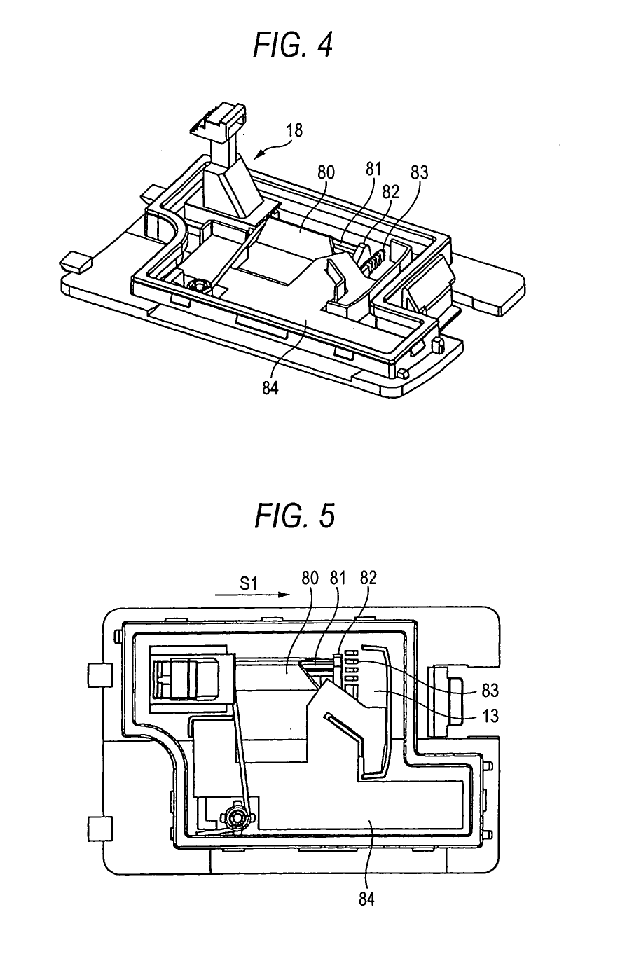

Next, a second constitution of the waste ink tank according to the first embodiment of the invention will be described with reference to FIGS. 4 and 5. FIG. 4 is a perspective view that explains the second constitution of the waste ink tank according to the first embodiment of the invention, in which the cover is opened. FIG. 5 is a plan view that explains the second constitution of the waste ink tank according to the first embodiment of the invention, in which the cover is opened.

Here, since parts other than a short slant surface 80, a different-in-level part 81, a bump part 82, a convex group 83, and an ink absorber 84 are similar to those in the first constitution of the waste ink tank, their description is omitted.

Firstly, the short slant surface 80 is shorter in its length in the longitudinal direction than the slant surface 19 in the first constitution. In the longitudinal direction of its slant surface 80 and at an end in the slide direction of the scraper 18, the different-in-level part 81 is provided, which is lower in height than the short slant surface 80 and has unevenness on its surface. At an end of this different-in-level part 81 on the opposite side to the short slant surface 80 side, the bump part 82 is provided, which bumps against the scraper 18 when the scraper 18 slides. A part of the ink absorber 84 extends to the neighborhood of this bump part 82, the different-in-level part 81, and the convex group 83. Further, the convex group 83 comprising plural projections is provided for the waste ink storing part 13.

Under this constitution, the scraper comes into contact with the waste ink ejected on the short slant surface 80 from the ink nozzle due to the waste ejection, and scrapes it while sliding. Then, this scraped waste ink drops to the different-in-level part 81, is held in the unevenness on the surface of this different-in-level part 81, and is prevented from turning to the short slant surface 80. Further, the waste ink held in the unevenness on the surface of this different-in-level part 81 is absorbed into the ink absorber 84 extending to the neighborhood of the different-in-level part 81. Further, the scraped waste ink drops from the scraper 18 also by collision of the scraper 18 with the bump part 82, and is absorbed into the ink absorber 84 extending to the neighborhood of the bump part 82.

Further, the waste ink that has flown out without being absorbed in the ink absorber 84 by the different-in-level part 81 and the bump part 82 is held also in the convex group 83 of the waste ink storing part 13, and absorbed into the ink absorber 84 extending to the neighborhood of the convex group 83.

Further, a part of this ink absorber 84, in case that the scraper 18 is slid in the direction S1, comes into contact with the scraper 18 and interferes with the scraper 18. Its part is compressed intentionally and yields, and refuse of the waste ink pressed by the scraper 18 is easy to be attached to its part. Therefore, using this yielding phenomenon of the ink absorber 84 well, the inside of the waste ink tank is cleaned.

Therefore, compared with the first constitution of the waste ink tank, the waste ink can be efficiently held and absorbed.

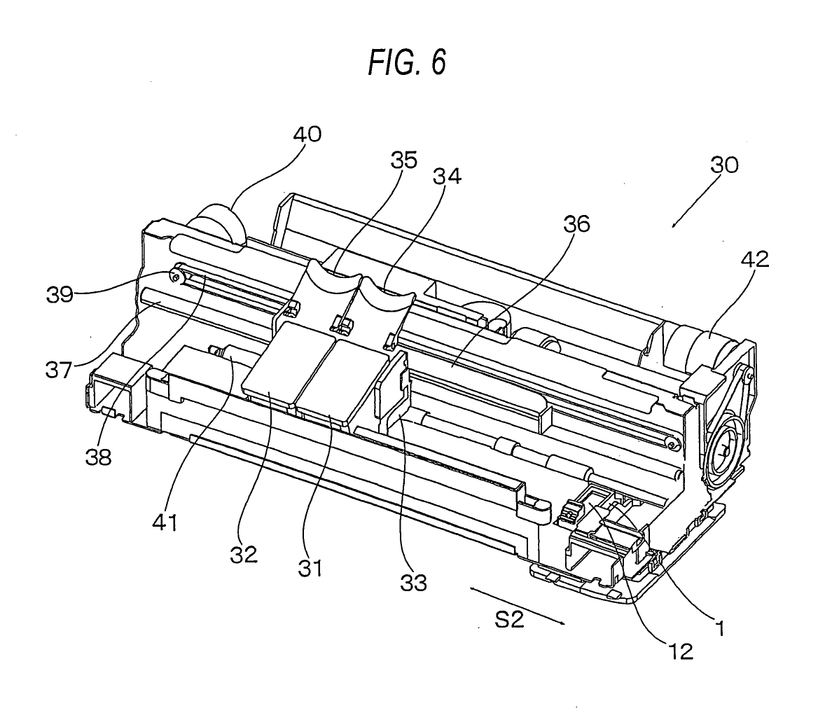

Next, an ink jet printer apparatus using the waste ink tank thus constructed according to the first embodiment of the invention will be described with reference to FIG. 6.

FIG. 6 is a perspective view of a printer section of the ink jet printer apparatus using the waste ink tank according to the first embodiment of the invention.

As shown in FIG. 6, a printer section 30 of the ink jet printer apparatus provided with the waste ink tank 1 has a black ink cartridge 31 in which a pigment is used, and a mixed color ink cartridge 32 in which a dye is used.

A carriage 33, provided with these ink cartridges 31 and 32, scans in the direction S1 in FIG. 3. Ink cartridge holding parts 34 and 35 are connected to the carriage 33 and hold the ink cartridges 31 and 32.

A flexible cable 36 connects an ink nozzle and a body control section (not shown).

A carriage shaft 37 for guiding the carriage 33 in the direction S1 is fixed to the carriage 33, and a timing belt 38 which transmits power for moving this carriage 33 in the direction S1 is laid on pulleys 39 arranged on both sides of the apparatus.

To one pulley 39, drive power is transmitted through a transmission mechanism such as a gear by a carriage motor 40.

A drive roller 41 is used in order to transport a printing medium, and driven by a feed motor 42.

The waste ink tank 1 is provided at one side end of the printer section 30. When a black ink nozzle (not shown) which ejects the pigment hardening with passage of time moves to one side end and ejects the waste ink, the waste ink inlet 11 is exposed so that the waste ink can be introduced into the waste ink tank.

The lever 17 of the waste ink tank 1 protrudes from the printer section 30 so that an operator can press the lever 17 when he opens a cover of the ink jet printer apparatus into which the printer section 30 is incorporated.

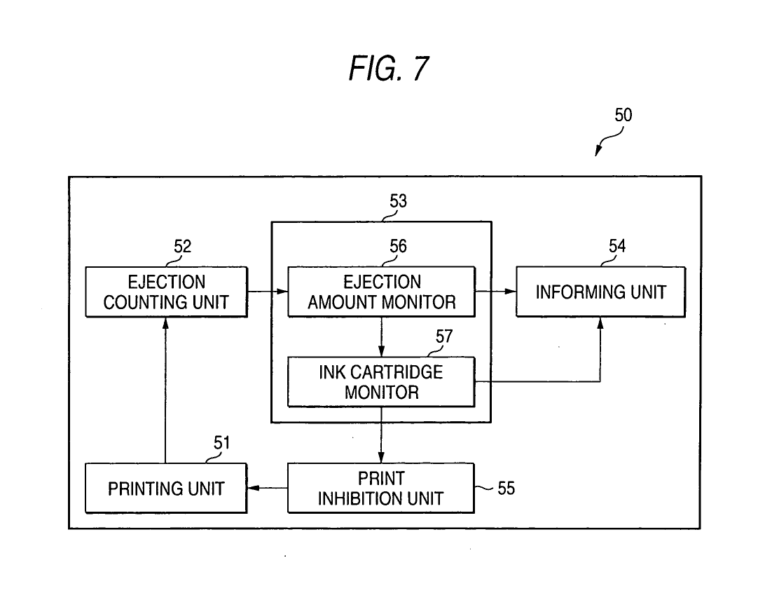

Next, the constitution of a control section of the ink jet printer apparatus using the waste ink tank according to the first embodiment of the invention will be described. FIG. 7 is a diagram showing the constitution of the control section of the ink jet printer apparatus using the waste ink tank according to the first embodiment of the invention.

As shown in FIG. 7, a control section 50 of the ink jet printer apparatus comprises a printing unit 51, an ejection counting unit 52, a monitor 53, an informing unit 54, and a print inhibition unit.

The printing unit 51 performs data transmission and reception between the outside and the printer section; control of various sensors such as an ink cartridge attaching sensor, a printing medium setting sensor, and a cover-open sensor; control of various motors such as a printing medium transporting motor and an ink nozzle driving motor; and control which causes the ink nozzle to eject the ink.

Further, the printing unit 51 holds the last printing time data, and performs such control that waste ejection is performed in relation to the waste ink tank 1 in order to clean the ejection port of the ink nozzle in case that a time interval of printing becomes larger than the predetermined time.

The ejection counting unit 52, when an ejection instruction is given to the ink nozzle from the printing unit 51, counts the ejection amount from the number of the ejected dots. This counting, till the ink cartridge is exchanged, even if a power source of the ink jet printer apparatus is turned off, is held and continued.

The monitor 53 comprises an ejection amount monitor 56 and an ink cartridge monitor 57.

The ejection amount monitor 56 reads the value counted by the ejection counting unit 52 and monitors whether its value is a predetermined value (threshold limit value) or more. In case that the dot number that represents the amount of the ink ejected from the ink nozzle is the threshold limit value or more, the ejection amount monitor 56 informs the informing unit 54 of its fact, and the informing unit 54 informs the operator of its fact by a warning display or by sound. For example, in case that the capacity of one ink cartridge 31 is 19 ml, 400 millions dots to 600 millions dots, which represents the amount of the ink ejected from the ink nozzle, is taken as the threshold limit value, and the ejection amount monitor 56 monitors whether the number of dots ejected from the ink nozzle is the threshold limit value or more. In case that the amount of the ink ejected from the ink nozzle is the threshold limit value or more, the ejection amount monitor 56 informs the informing unit 54 of its fact, and informs the print inhibition unit 55 of print inhibition.

The ink cartridge monitor 57, in case that it has been informed by the ejection amount monitor 56 that the ejection amount is the threshold limit value or more, according to how many ink cartridges 1 have been exchanged from the last cleaning of the waste ink tank 1, informs the informing unit 54 of exchange of the ink cartridge 31 and cleaning of the waste ink tank. This is because: in case that the number of the exchanged ink cartridges 31 is the predetermined number (threshold limit value) or more, it is judged that the waste ink hardening by the waste ejection of the ink nozzle is piled up on the slant surface 19 of the waste ink tank 1, and the height of the piled waste ink reaches the height by which the waste ink inlet 12 is clogged. In case that printing is continued as it is and the waste ejection of the ink nozzle is performed, there is fear that the waste ink leaks from the waste ink inlet 12 of the waste ink tank 1 and the printing medium during printing and surroundings of the waste ink tank 1 are stained with the leaking waste ink. For example, when printing is performed using the four ink cartridges 31, in case that the hardening waste ink leaks from the waste ink inlet 12 of the waste ink tank 1, the ink cartridge monitor 57 monitors whether the present ink cartridge 31 is the fourth ink cartridge 31 from the last cleaning of the waste ink tank 1.

Counting of the exchange number of the ink cartridges 31, till a cleaning completing operation of the waste ink tank is performed by the operator, even if the power source of the ink jet printer apparatus is turned off, is held and continued.

As displaying methods by the informing unit 54, there are message display by a liquid crystal display, lighting or flashing display by a light emitting diode, display by continuous or intermittent buzzer sound from a speaker, and display by synthetic sound.

The print inhibition unit 55, upon reception of the information from the ink cartridge monitor 57, informs the printing unit of printing inhibition, and waits for completion inputs of the cartridge exchange and of cleaning of the waste ink tank 1 by the operation. When the print inhibition unit 55 receives the completion inputs of the exchange and cleaning, it instructs the printing unit 51 on printing resumption.

In the control section 50, the printing unit 51, the ejection counting unit 52, the ejection amount monitor 56, the ink cartridge monitor 57, and the print inhibition unit 55 can be constituted by an MPU (Micro Processing Unit) such as a microprocessor, a ROM (Read Only Memory) storing a control program, and a RAM (Random Access Memory) in which a program is used for reading and writing.

In the printer section of the thus constructed ink jet printer apparatus using the waste ink tank according to the first embodiment of the invention, its operation will be described with reference to FIGS. 1 to 7.

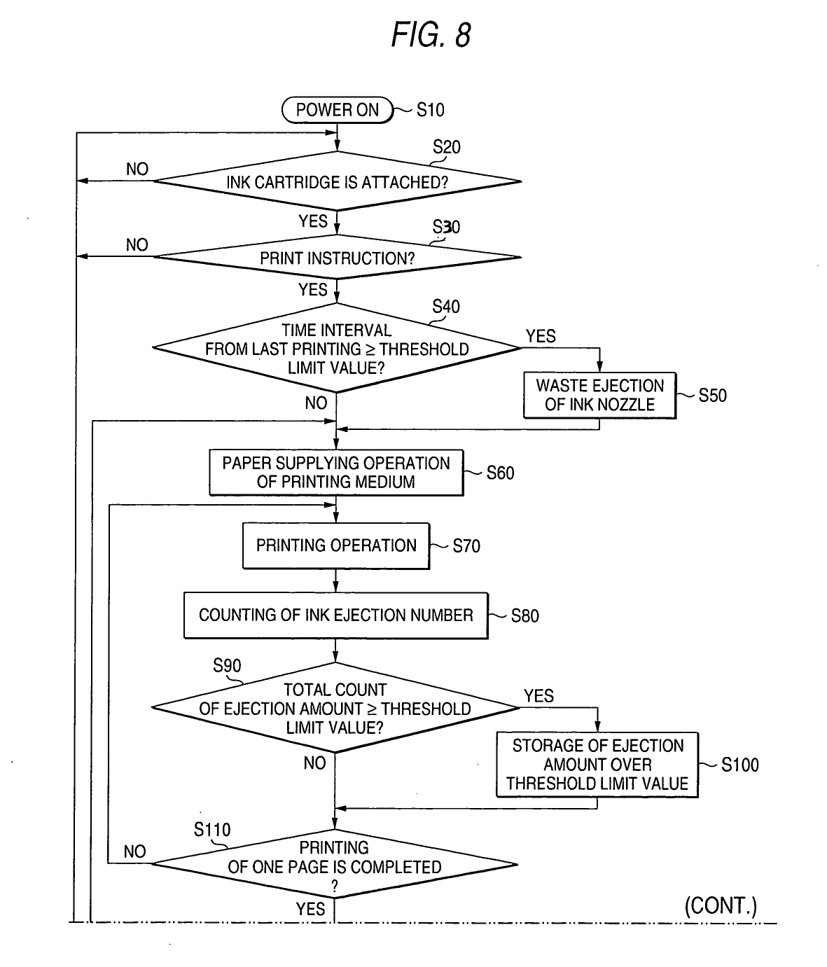

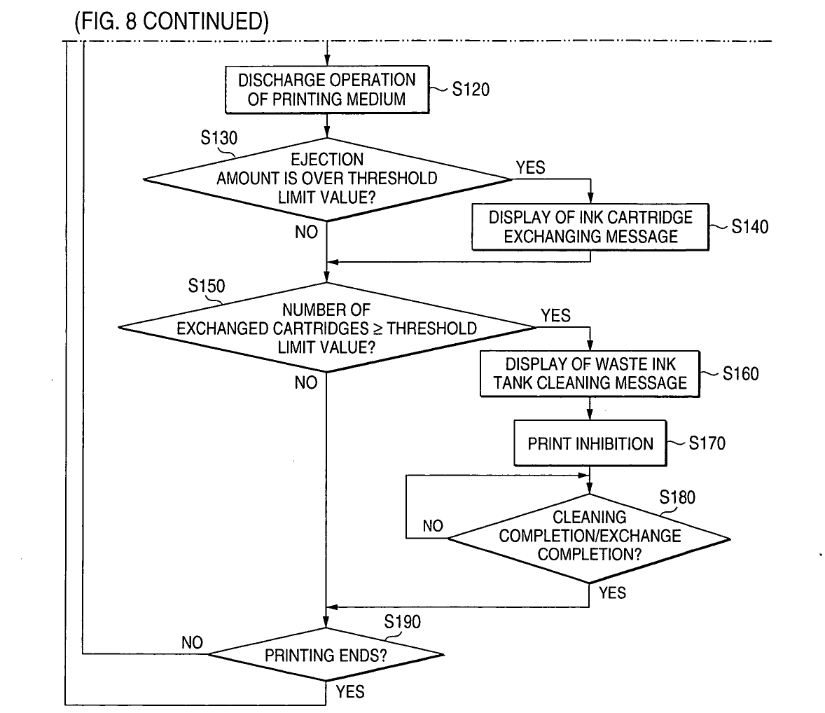

FIG. 8 is a flowchart that explains the operation of the ink jet printer apparatus using the waste ink tank according to the first embodiment of the invention.

As shown in FIG. 8, when a power source is turned on (S10), the printing unit 51 monitors whether the ink cartridges 31, 32 are attached or not. In case that they have not been attached yet, the printing unit 51 waits for their attachment, and does not perform printing even if it receives a printing instruction at this time (S20).

The printing unit 51 waits the printing instruction from the outside. In case that there is not the printing instruction, the control section proceeds to the step S20. In case that there is the printing instruction, the control section proceeds to a step S40 (S30).

The printing unit 51 holds the last printing time data, and judges whether a time interval of printing becomes longer than the predetermined time or not. In case that the time interval of printing becomes longer than the predetermined time, the control section proceeds to a step S50. In case that the time interval of printing becomes shorter than the predetermined time, the control section proceeds to a step S60 (S40).

The printing unit 51, in order to clean the ejection port of the ink nozzle because the time interval of printing becomes long, moves horizontally the ink nozzle to the upside of the waste ink inlet 12 of the waste ink tank 1, and stops it. The waste ejection is performed in relation to the waste ink tank, and the control section proceeds to a step S60. Since the ink jet printer apparatus performs this waste ejecting operation, the ejected waste ink stores in the waste ink tank 1 and hardens with passage of time, and the ink that has hardened is piled up gradually (S50).

The printing unit 51 supplies the printing medium (S60) and starts the printing operation (S70).

In this time, the ejection counting unit 52 counts the ink ejection number from which the amount of ink ejected from the ink nozzle can be calculated (S80).

The ejection amount monitor 56 reads the value counted by the ejection counting unit 52. In case that the capacity of one ink cartridge is 19 ml, the monitor 56 monitors whether the ejection amount of ink from the ink nozzle is 500 millions dots of the threshold limit value or more. In case that the ejection amount of the ink from the ink nozzle is the threshold limit value or more, the control section proceeds to a step S100 (S90).

The ejection amount monitor 56 holds the data that the ejection amount is 500 millions dots of the threshold limit value or more, informs the ink cartridge monitor 57 of this fact, and continues printing (S100).

The printing unit 51 judges whether printing of one page data has been completed or not. In case that printing has not been completed yet, the control section returns to the step S70 and printing is continued (S110).

The printing unit 51, in case that printing of one page data has been completed, discharges the printing medium (S120).

The ejection amount monitor 56, in printing on the printing medium, judges whether the total of the ejection amount is the threshold limit value or more, and judges the result obtained from its judgment (S130). In case that the total of the ejection amount is the threshold limit value or more, the monitor 56 informs the informing unit 54 of the ink cartridge exchange. The informing unit 54 displays a message such as ┌Ink cartridge exchange┘ in a liquid crystal display (S140).

The ink cartridge monitor 57 receives the data from the ejection amount monitor 56 in the step S100, and judges how many ink cartridges 31 have been used from the last cleaning of the waste ink tank 1.

The ink cartridge monitor 57, taking the threshold limit value of the exchanged ink cartridges as four, in case that the three ink cartridges 31 are used from the last cleaning of the waste ink tank, and the fourth ink cartridge 31 is about to be used, informs the informing unit 54 and the print inhibition unit 55 of its fact, and the control section proceeds to a step S160. In case that the number of the exchanged ink cartridges is not the predetermined number or more, the control section proceeds to a step S190 (S150).

The ink cartridge monitor 57 informs the informing unit 54 of data of a cleaning request of the waste ink tank. The informing unit 54 informs the operator of the cleaning request of the waste ink tank. For example, the informing unit 54 displays a message of ┌waste ink tank cleaning┘ in the liquid crystal display (S160).

The print inhibition unit 55, in order to stop sequential printing, informs the printing unit 51 of printing inhibition (S170).

The printing unit 51 continues to wait for the operation till the operator performs the operations of cleaning completion of the waste ink tank 1, and of exchange completion of the ink cartridges 31, 32. Upon reception of input of their operations, the control section proceeds to a step S190. Here, the operator pushes the lever 17 of the scraper 18 of the waste ink tank 1 by his finger, and moves, while sweeping the waste ink on the slant surface 19 that has hardened with the passage of time, the scraped waste ink to the waste ink storing part 13. Next, he exchanges the ink cartridges 31, 32 into new ink cartridges, and informs the ink jet printer apparatus that the operation has been completed (S180).

The printing unit 51 judges whether data to be printed remains or not. In case that it is necessary to perform printing sequentially, the control section proceeds to the step S60. In case that there is no data to be printed, the control section proceeds to the step S20 (S190).

Though the first embodiment of the invention has been described above, the invention is not limited to this embodiment. For example, in the waste ink tank, the energizing member connected to the scraper may be a helical spring, one end of the helical spring can be connected to the scraper, and the other end of the helical spring can be connected to the wall part or the base part. Hereby, after the scraper has been slid to scrape the waste ink that has hardened, it can return to the first position by the energizing power of the helical spring.

Further, the ink absorber, since the sweeping mechanism is arranged aside on one side of the waste ink tank, is arranged on only one side of the sweeping mechanism. However, the sweeping mechanism may be arranged in the center of the waste ink tank, and the ink absorber may be provided on both sides of the sweeping mechanism.

Further, in the ink jet printer apparatus, in this embodiment, the waste ink tank is cleaned using the plural ink cartridges. However, when the operator is informed that the waste ink tank is cleaned using one ink cartridge, the ejection amount monitor of the monitor unit monitors the ejection amount of the ink nozzle, and can inform the informing unit of the ink cartridge exchange and of the cleaning request of the waste ink tank in case that the ejection amount is the threshold limit value or more, whereby the ink cartridge monitor can be omitted.

Further, the informing unit, by performing transmission to a terminal provided in a remote plate using a channel, may inform its terminal of a warning.

(Second Embodiment)

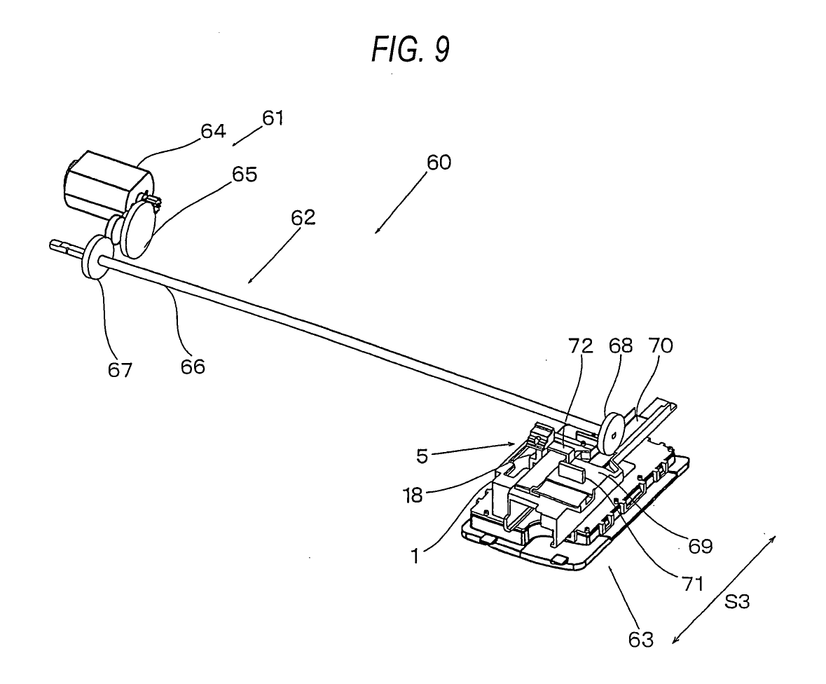

An ink jet printer apparatus using a waste ink tank according to a second embodiment of the invention will be described with reference to FIG. 9.

FIG. 9 is a perspective view showing an example of constitutions of a cleaning unit and a waste ink tank cleaning unit of the ink jet printer apparatus using the waste ink tank according to the second embodiment of the invention.

Since the waste ink tank used in the second embodiment is the same in constitution as the waste ink tank in the first embodiment, parts of the waste ink tank in the second embodiment are denoted by the same reference numerals, and their description is omitted.

As shown in FIG. 9, a cleaning unit 60 transmits rotation of a drive motor mounted at one end of a printer section of the ink jet printer apparatus to the other end, moves horizontally a sweeping mechanism 5 of a waste ink tank 1 mounted on the other end, and moves the waste ink that has been stored in the waste ink tank 1 and hardened.

The cleaning unit 60 comprises a drive part 61, a drive transmission part 62, and a horizontally moving part 63.

The drive part 61 comprises a drive motor 64, and a gear 65 for transmitting the rotation of the drive motor 64. The rotation of the drive motor 64 is transmitted through the gear 65 to the drive transmission part 62.

The drive transmission part 62 comprises a drive transmitting shaft 66 for transmitting the rotation from one end of the printer section to the other end, a rotation driving spur gear 67 fixed to one end of the drive transmitting shaft 66, and horizontal drive spur gear 68 fixed to the other end of the drive transmitting shaft 66.

The rotation drive spur gear 67 transmits the rotation of the gear 65 to the drive transmitting shaft 66, and the horizontal drive spur gear 68 transmits the rotation of the drive transmitting shaft 66 to the horizontally moving part 63.

The horizontally moving part 63 comprises a base part 69 moving horizontally, a rack 70, a wiper 71, and a waste ink tank coupling part 72 that is a waste ink tank cleaning unit.

The rack 70 is fixed onto the base part 69, and converts the rotation of the horizontal drive spur gear into a horizontal movement thereby to slide the base part 69 in a direction S2.

The wiper 71 is made of rubber, and wipes, when an ink nozzle is located upward of the base part 69, an ejection port of the ink nozzle by the slide of the base part 69 in the direction S2.

The waste ink tank coupling part 72 is detachably coupled to a scraper 18 of the waste ink tank 1, and slides the scraper 18 in the direction S2 with the slide of the base part in the direction S2.

The operation of the thus constructed cleaning unit of the ink jet printer apparatus using the waste ink tank according to the second embodiment of the invention will be described below.

Firstly, by an instruction of a control section (not shown), the ink nozzle is moved upward of the base part 69 and to a range in which the wiper 71 moves horizontally, and stands ready.

Next, the drive motor 64, by an instruction of the control section (not shown), rotates clockwise viewed from a rotational shaft protruding from the drive motor 64.

The gear 65 transmits the clockwise rotation of the drive motor 64, viewed in the direction of the rotation driving spur gear 67 from the horizontal drive spur gear 68, to the rotation driving spur gear 67 fixed to the drive transmitting shaft 66, whereby the drive transmitting shaft 66 rotates counterclockwise, and the horizontal drive spur gear 68 rotates in the same direction.

Then, by the counterclockwise rotation of the horizontal drive spur gear 68, viewed in the direction of the rotation driving spur gear 67 from the horizontal drive spur gear 68, the rack 70 moves horizontally to the right viewed in the same direction. With the horizontal movement of the rack 70, the base part 69 also moves horizontally to the right. Therefore, the wiper also moves horizontally, and wipes the ejection port of the ink nozzle standing ready upward of the base part 69, and the waste ink tank coupling part 72 moves horizontally the scraper 18 on the base part 69.

This scraper 18 slides to the right viewed in the direction of the rotation driving spur gear 67 from the horizontal drive spur gear 68, whereby it can scrape and sweep the waste ink that has hardened on a slant surface 19 of the waste ink tank 1 with the passage of time.

In case that the amount of the waste ink stored in the waste ink tank 1 is about to exceed the storable capacity, coupling between the scraper 18 of the waste ink tank 1 and the waste ink tank coupling part 72 is released, and the waste ink tank 1 is taken out from the ink jet printer apparatus and discarded.

Though the second embodiment of the invention has been described above, the invention is not limited to this embodiment. For example, the drive motor may be provided at the other end so that the gear directly drives the horizontal drive spur gear, and the drive shaft may be omitted. Further, a period for which the amount of the waste ink stored in the waste ink tank 1 has exceeded the storable capacity is longer than a life of the apparatus, the cleaning unit may be constituted so that coupling between the scraper 18 of the waste ink tank 1 and the waste ink tank coupling part 72 can not be released.

(Third Embodiment)

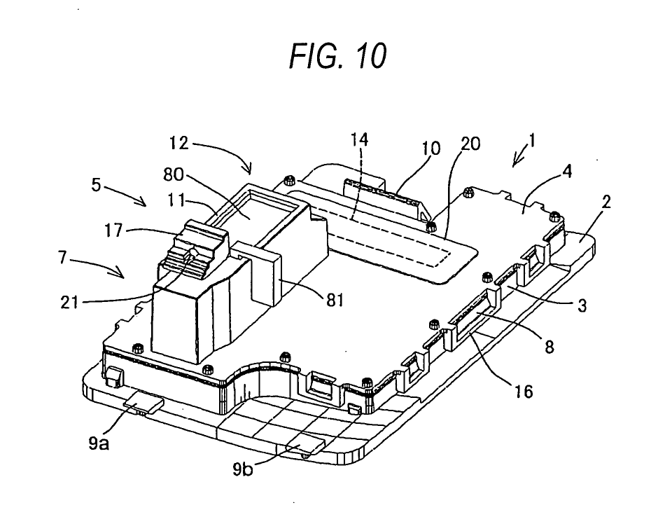

An ink jet printer apparatus using a waste ink tank according to a third embodiment of the invention will be described with reference to FIGS. 10 to 14B.

In the cover 4, a waste ink introducing part 11 is formed protrusively, which catches the waste ink ejected from an ink nozzle (not shown) and leads it into a storing part 7. In the waste ink introducing part 11, an opening part is formed, and a shutter 80 which opens and closes the opening part is slidably provided in parallel with the surface of the base plate 2. This shutter 80 is so constituted as to be opened and closed by moving a shutter lever 81 from the outside. The shutter 80 may have, in addition to the constitution in which a plate-shaped member slides, the constitution in which a bellows-like member opens and closes like a curtain, or another constitution.

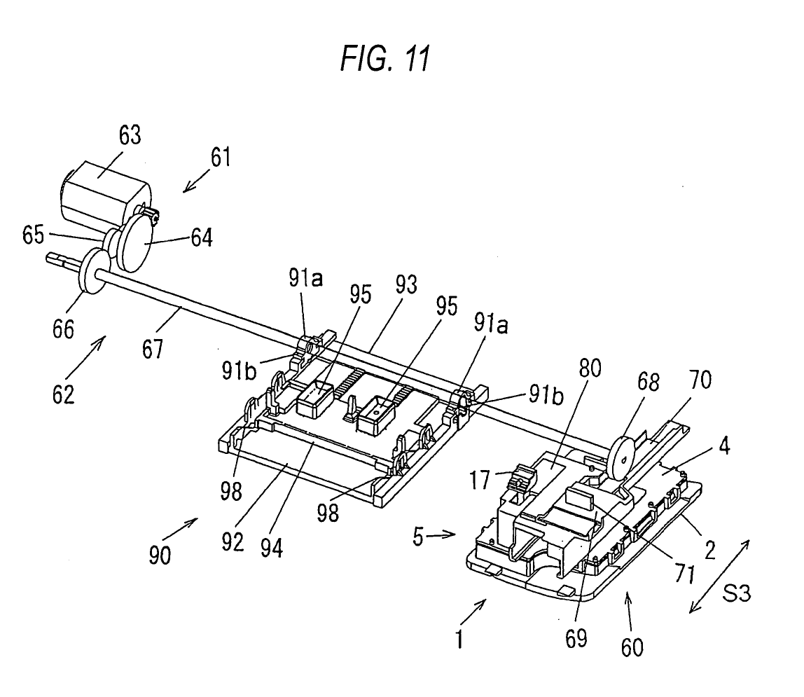

In FIG. 11, an automatic opening and closing mechanism 60 receives drive power from a drive part 61 and a drive transmitting part 62, and cooperates with a capping unit 90.

The drive part 61 comprises a drive motor 63, and gears 64 and 65 for transmitting rotation of the drive motor 63, and transmits the rotation of the drive motor 63 to the drive transmitting part 62.

The drive transmitting part 62 comprises a gear 66 which receives the rotation power of the drive motor 63 from the gear 65, a drive transmission shaft 67, and a pinion gear 68 fixed to the other end of the drive transmission shaft 67.

The pinion gear 68 transmits the rotation of the drive transmission shaft 66 to the automatic opening and closing mechanism 60.

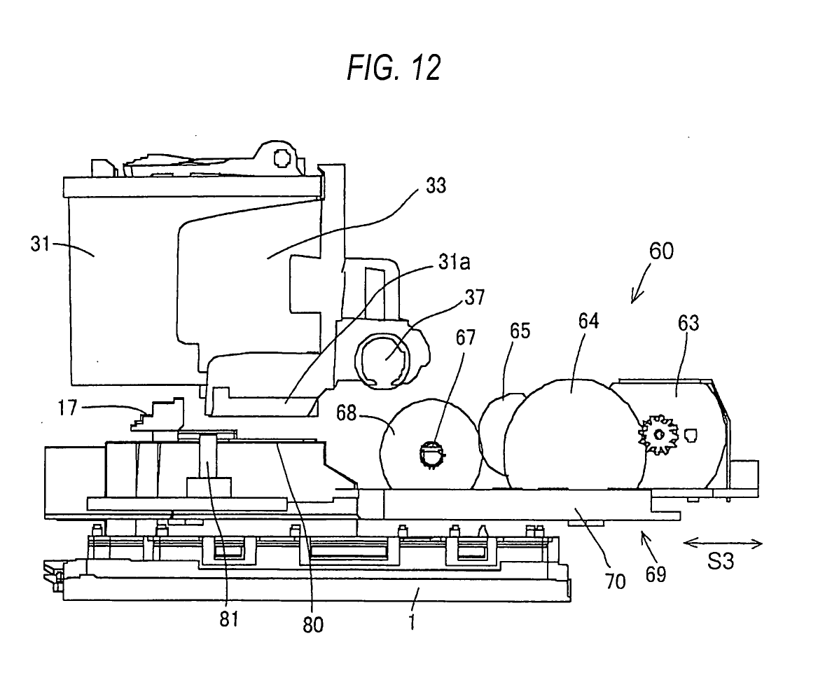

As shown in FIGS. 11 and 12, the automatic opening and closing mechanism 60 comprises a base part 69 which moves horizontally, a rack 70, a joint bar 71 which drives a shutter lever 81 for opening and closing the shutter 80.

The rack 70 is fixed to the base part 69, converts the rotation of the pinion gear 68 into horizontal movement, and slides the base part 69 in a direction S3.

In the embodiment, the scraper 18 is caused to cooperate with the shutter lever 81. Every time the shutter 80 opens and closes, the scraper 18 moves, whereby sweeping of the waste ink into the waste ink tank 2 by the sweeping part 5 is performed.

The capping unit 90, as shown in FIG. 11 and FIG. 7A and FIG. 7B, includes a base 92, a slide base 93 movable in the horizontal direction in relation to this base 92, a cap base 94 which can rise and fall in relation to this slide base 93, and a cap 95 attached to this cap base 94 through a spring 96.

The slide base 93 is a product molded of plastic, in which a rack 97 which engages with a pinion gear 91b engaging with a gear 91 fixed to the drive transmission shaft 67, and a ramp part 98 which converts the horizontal movement of the slide base 93 into the up and down movement of the cap base 94 are integrally formed.

For the cap base 94, a carriage lock bar 99 is further provided. The carriage lock bar 99, when the cap base 94 rises, fits into a lock receiver 33a of the carriage 33 thereby to perform positioning of the cap 95.

Onto the upper surface of the cap 95, a seal member (not shown) such as rubber sticks at its portion which comes into contact with a head 31a of the ink cartridge 31, and presses the head 31a air-tightly by elastic force of the spring 96.

Next, the operation of the ink jet printer apparatus having the automatic opening and closing mechanism of the shutter of the waste ink tank according to the embodiment of the invention will be described.

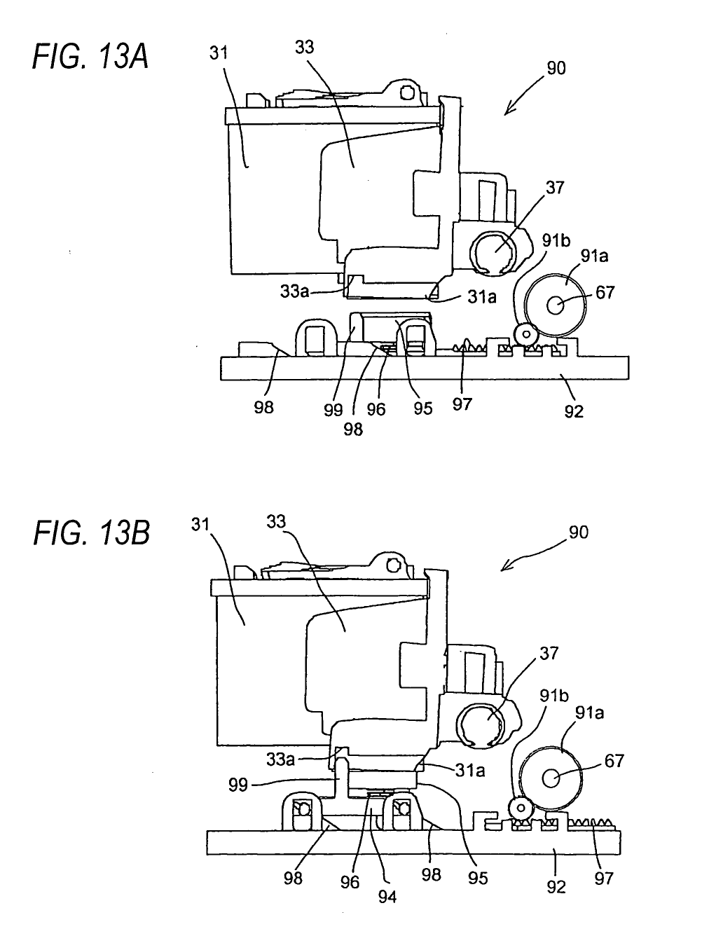

Firstly, in a state where the power switch of the ink jet printer apparatus is turned off, the ink cartridges 31, 32 are located in capping positions, and the heads 31a, 32 (not shown) are capped with the cap 95 (state shown in FIG. 13B) by the capping unit 90. Further, the waste ink inlet 12 of the waste ink tank 1 is closed by the shutter 80 (state shown in FIG. 12).

When the power switch is turned on, the drive motor 63 rotates, and the drive transmission shaft 67 is rotated counterclockwise on the drawing. Then, as shown in FIG. 7A, the gear 91a rotates counterclockwise, and the pinion gear 91b rotates clockwise, whereby the rack 97 is moved to the left thereby to move the slide base 93 to the left. When the slide base 93 moves to the left, the cap base 94 that has been raised by the ramp part 98 formed in the slide base 93 falls, the carriage lock bar 99 separates from the lock receiver 33a of the carriage 33, and the cap 95 separates from the heads 31a, 32a of the ink cartridges 31, 32, so that the capping state is released (refer to FIG. 7A).

When, in synchronization with this operation, the drive transmission shaft 67 rotates counterclockwise, as shown in FIG. 6, the rack 70 moves to the right, and slides the shutter 80 in the right direction through the joint bar 71 and the shutter lever 81, so that the waste ink inlet 12 of the waste ink tank 1 is opened.

Hereby, printing by the ink cartridges 31, 32 is made possible, and the waste ejection by the ink cartridges 31, 32 into the waste ink tank 1 can be performed at the predetermined timing.

When an off-button of the power switch is pushed on, the drive motor rotates the drive transmission shaft 67 clockwise, and the rack 70 moves to the left and slides the shutter 80 to the left by the joint bar 71 and the shutter lever 81, so that the waste ink inlet 12 of the waste ink tank 1 is closed.

Simultaneously, the gear 91a of the capping unit 90 rotates clockwise, and the pinion gear 91b rotates counterclockwise, whereby the rack is moved to the right and the slide base 93 is moved to the right. When the slide base 93 moves to the right, the cap base 94 rises by the ramp part 98 formed in the slide base 93, the carriage lock bar 99 is fitted into the lock receiver 33a of the carriage 33, and the cap 95 is attached closely to the heads 31a, 32a of the ink cartridges 31, 32 and performs capping at the constant pressure by the spring 96, so that clogging of ink into the ink nozzle is suppressed.

After completion of this operation, an electronic switch operates, and a main power switch of the ink jet printer apparatus is turned off.

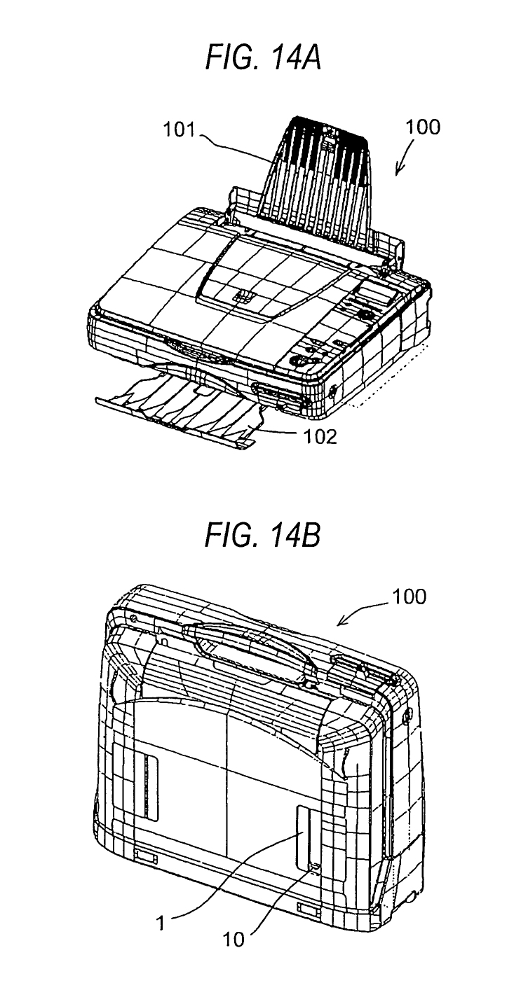

FIGS. 14A and 14B are perspective views showing a portable color facsimile 100 which is an example of the ink jet printer apparatus mounted with the ink jet engine 30 according to the embodiment of the invention, in which FIG. 14A shows an emplacement state, and FIG. 14B shows a longitudinal placement state in the housing time or the carrying time. In the figure, reference numeral 101 is a paper supply tray, and reference numeral 102 is a paper discharge tray. As shown in FIG. 14B, in the longitudinal placement state, the waste ink tank 1 is in a longitudinal state. In this case, since the waste ink inlet 12 is in a sideways state, there has been conventionally a riskiness that the waste ink drops. However, since the shutter 80 is provided and it is closed by the automatic opening and closing mechanism 60 in power-off, it is prevented that the waste ink drops or the waste ink leaks in the apparatus.

In the above embodiment, as conditions of operating the automatic opening and closing mechanism 60 of the shutter 80 provided for the waste ink inlet 12 of the waste ink tank 1, ON and OFF of the power switch is taken as an example. However, it is detected that the housing of the ink jet printer apparatus has inclined, whereby the automatic opening and closing mechanism 60 may be operated.

For example, an inclination sensor is provided in the housing of the ink jet printer apparatus; and when the housing inclines at the predetermined angle or more, the drive motor 63 is rotated by output of the inclination sensor, the shutter 80 is closed, and capping of the heads of the ink cartridges 31, 32 is performed by the capping unit 90.

As the inclination sensor, various sensors can be used, for example, a pendulum sensor, a ball sensor, and a level sensor.

Hereby, for example, even if the ink jet printer apparatus is inclined or stood in a state where the power-switch is ON, the shutter 80 closes, so that the liquid waste ink and the solid ink refuse do not leak to the outside of the waste ink tank 1 or the outside of the ink jet printer apparatus.

Further, to operate the automatic opening and closing mechanism 60 by the output of this inclination sensor, and to operate the automatic opening and closing mechanism 60 by power ON-OFF can be used together.

As described above, according to the invention, the following effects are obtained.

(1) By providing the sweeping mechanism for the waste ink tank, it can be prevented that the waste ink inlet is clogged with the waste ink that is ejected from the ink nozzle for the waste ejection, hardens with the passage of time and is piled, and it can be prevented that only the amount of the waste ink that is smaller than the storable amount of the waste ink can be stored.

(2) The ink absorber in which the waste ink has been absorbed can be exchanged to a new ink absorber in which the waste ink has not been absorbed yet. Therefore, by only exchanging the ink absorber, the waste ink tank in which the ink absorber has been exchanged can be reused as a new waste ink tank. In result, industrial waste products can be reduced, and the waste ink tank which takes environment into consideration can be used.

(3) Since the scraper slid by the operator is energized in one direction thereby to return to its initial position automatically, forgetting to return the scraper is eliminated. Therefore, in the horizontal movement of the ink nozzle for the waste ejection, it is prevented that the ink nozzle collides with the scraper due to forgetting to return the scraper, so that damage of the ink nozzle due to collision can be prevented.

(4) Since the slide insertion part that is the recess part is formed in the scraper, the scraper 18 can be slid with a matter having a sharp leading end such as a pencil or a ballpoint pen. Therefore, even if that the operator does not put his finger into the ink jet printer apparatus, maintenance of the waste ink tank can be performed with the pencil or the ballpoint pen.

(5) The waste ink swept by the scraper is removed by the swab inserted from the opening provided for the storing part, whereby the amount of the waste ink that is stored into the waste ink tank and hardens can be reduced. Therefore, the maintenance of the waste ink tank can be readily performed.

(6) Since the sweeping mechanism has the slant surface, the waste ink ejected from the ink nozzle for the waste ejection can be diffused with power of ejection from the ink nozzle, and the waste ink can flow on the slant surface and sideward in the longitudinal direction of the slant surface, so that the amount of the residual waste ink on the slant surface can be reduced.

(7) In the ink jet printer apparatus provided with the waste ink tank of the invention, the counting unit counts the ejection amount of the ink and the monitor gives a warning when the counted number exceeds the predetermined amount. Therefore, a timing in which the waste ink is cleaned by the sweeping mechanism of the waste ink tank can be judged by the counting unit and the monitor, so that the maintenance of the waste ink tank is facilitated.

(8) The print inhibition unit, in case that the ejection amount exceeds the threshold limit value, inhibits the printing operation. Hereby, before the height of the waste ink that is ejected from the ink nozzle for the waste ejection, hardening with the passage of time, and piled up reaches the height with which the ink nozzle collides in the horizontal movement, the print inhibition unit can inhibit the printing operation. Therefore, in the horizontal movement of the ink nozzle for the waste ejection, the ink nozzle does not collide with the waste ink that has hardened and has been piled up, and the damage of the ink nozzle can be prevented.

(9) The ink ejecting surface of the ink nozzle is wiped and the sweeping mechanism is horizontally moved, whereby the waste ink ejected from the ink nozzle, even if it is hardening with the passage of time, can be moved without the operation by the operator. Therefore, it can be prevented that the ink nozzle that moves horizontally in the waste ejection collides with the hardening waste ink that is piled up, due to forgetting of the operation of the sweeping mechanism.

(10) The invention can be available as the ink jet printer apparatus which can prevent the waste ink from leaking to the outside of the ink jet printer apparatus in case that the ink jet printer apparatus mounted with the ink jet engine having the waste ink tank is carried in the longitudinal placement state or inclined.

This application is based upon and claims the benefit of priority of Japanese Patent Application Nos. 2003-198319 filed on Jul. 17, 2003 and 2003-368665 filed on Oct. 29, 2003, the contents of which are incorporated herein by reference in its entirety.

1. A waste ink tank comprising:
an attaching part onto which ink ejected from an ink nozzle is attached;
a gathering member that gathers the ink attached onto said attaching part; and
a storing part that stores the ink gathered by said gathering member.

2. A waste ink tank provided with a storing part that stores waste ink ejected from an ink nozzle, comprising:
an attaching part onto which the waste ink ejected from said ink nozzle is attached; and
a sweeping mechanism for sweeping the waste ink attached onto said attaching part to said storing part.

3. The waste ink tank according to claim 2, wherein an ink absorber that stores the waste ink ejected from said ink nozzle is provided for said storing part.

4. The waste ink tank according to claim 3, wherein said ink absorber is exchangeable.

5. The waste ink tank according to claim 2, wherein said sweeping mechanism comprises a slant surface for leading said waste ink to said ink absorber, and a scraper that comes into contact with the slant surface and slides.

6. The waste ink tank according to claim 5, wherein said scraper is energized in one of sliding directions.

7. The waste ink tank according to claim 5, wherein said scraper has a lever for slide, and a slide insertion part that is a recess part is formed in said lever.

8. The waste ink tank according to claim 5, wherein an opening through which the waste ink swept by said scraper is removed is provided for said storing part.

9. An ink jet printer apparatus provided with the waste ink tank according to claim 1.

10. An ink jet printer apparatus provided with a waste ink tank including a storing part that stores waste ink ejected from an ink nozzle, an attaching part onto which the waste ink ejected from said ink nozzle is attached, and a sweeping mechanism for sweeping the waste ink attached onto said attaching part to said storing part, characterized by including a counting unit that counts the amount of the ink ejected from said ink nozzle, and a monitor that gives an warning in case that said ejection amount input from said counting unit exceeds the predetermined value.

11. The ink jet printer apparatus according to claim 10, wherein there is provided an inhibition unit which inhibits a printing operation in case that the monitor has detected that said ink ejection amount exceeds the predetermined value.

12. An ink jet printer apparatus provided with a waste ink tank including a storing part that stores waste ink ejected from an ink nozzle, an attaching part onto which the waste ink ejected from said ink nozzle is attached, and a sweeping mechanism for sweeping the waste ink attached onto said attaching part to said storing part,
wherein there is provided a cleaning unit that wipes an ink ejection surface of said ink nozzle, and
said cleaning unit includes a waste ink tank cleaning unit that operates said sweeping mechanism in wiping of the ejection surface of said ink nozzle.

13. A waste ink tank comprising:
an attaching part in which a slant part onto which ink ejected from an ink nozzle is attached is provided;
a gathering member that gathers the ink attached onto said attaching part;
a storing part that stores the ink gathered by said gathering member; and
an ink absorber for absorbing the ink, which is provided for said storing part.

14. A waste ink tank comprising:
an attaching part in which a slant part onto which ink ejected from an ink nozzle is attached is provided;
a gathering member that gathers the ink attached onto said attaching part in a direction nearly perpendicular to the slant direction of the attaching part;
a different-in-level part which is provided on the side where the ink is gathered by said gathering member and lower in height than said attaching part; and
a storing part that stores the ink gathered by said gathering member.

15. A waste ink tank comprising:
an attaching part in which a slant part onto which ink ejected from an ink nozzle is attached is provided;
a gathering member that gathers the ink attached onto said attaching part in a direction nearly perpendicular to the slant direction of the attaching part;
a different-in-level part which is provided on the side where the ink is gathered by said gathering member, and lower in height than said attaching part;
a bump part which is provided on the opposite side to said attaching part side of said different-in-level part and which said gathering member bumps against; and
a storing part that stores the ink gathered by said gathering member.

16. A waste ink tank comprising:
an attaching part in which a slant part onto which ink ejected from an ink nozzle is attached is provided;
a gathering member that gathers the ink attached onto said attaching part in a direction nearly perpendicular to the slant direction of the attaching part;
a different-in-level part which is provided on the side where the ink is gathered by said gathering member, and lower in height than said attaching part;
a bump part which is provided on the opposite side to said attaching part side of said different-in-level part and which said gathering member bumps against;
a storing part that stores the ink gathered by said gathering member; and
plural projections provided for said storing part.

17. A waste ink tank comprising:
an attaching part in which a slant part onto which ink ejected from an ink nozzle is attached is provided;
a gathering member that gathers the ink attached onto said attaching part in a direction nearly perpendicular to the slant direction of the attaching part;
a different-in-level part which is provided on the side where the ink is gathered by said gathering member, lower in height than said attaching part, and has unevenness on its surface;
a bump part which is provided on the opposite side to said attaching part side of said different-in-level part and which said gathering member bumps against;
a storing part that stores the ink gathered by said gathering member;
plural projections provided for said storing part; and
an ink absorber which is arranged near said different-in-level part, said bump part or said projections, and compressed by contact of said gathering member.

18. An ink jet printer apparatus characterized in that:
a shutter for tightly closing an ink inlet is provided for the ink inlet of a waste ink tank, said waste ink tank comprising an attaching part to which ink ejected from an ink nozzle is attached, a gathering member that gathers the ink attached to said attaching part, and a storing part that stores the ink gathered by said gathering member; and
an automatic opening and closing mechanism for said shutter is provided.

19. The ink jet printer apparatus according to claim 18, wherein the automatic opening and closing mechanism of said shutter cooperates with an operation of an capping unit that caps said ink nozzle, closes said shutter in capping, and opens said shutter in capping release.

20. The ink jet printer apparatus according to claim 18, wherein the automatic opening and closing mechanism of said shutter cooperates with ON and OFF of a power switch.

21. The ink jet printer apparatus according to claim 18, wherein the automatic opening and closing mechanism of said shutter cooperates with an operation of a sensor which detects an inclination of a housing of said ink jet printer apparatus.

22. The ink jet printer apparatus according to claim 18, wherein said shutter slides along a surface parallel to an opening of said waste ink inlet.
